(19) United States
(12) Patent Application Publication
(10) Pub. No.: US 2012/0055640 A1
(43) Pub. Date: Mar. 8, 2012

(54) Easy Curtain Structure

(76) Inventor: Ming-Che Wu, Putze City (TW)

(21) Appl. No.: 12/874,614

(22) Filed: Sep. 2, 2010

(51) Int. Cl. E06B 9/24; A47H 99/00

(52) U.S. Cl. 160/352; 160/368.1

(57) ABSTRACT

An easy curtain structure contains a curtain piece formed in a continuous curve and concave shape, allowing to be folded, including a plurality of bores disposed on a number of raised folding ribs thereof respectively in a cross arrangement, and including at least one positioning structure mounted on a top and a bottom ends thereof respectively so as to be expended and to be fixed by using the positioning structure, wherein the positioning structure includes at lease one sucker fixed on the top and the bottom ends of the curtain piece, thereby the sunshine is stopped to directly shine indoors by the continuously curved and concaved curtain piece or through the bores to obtain heatproof, anti-sun, and bright effect.

### BACKGROUND OF THE INVENTION

1. Field of the Invention

The present invention relates to an easy curtain structure that the sunshine is stopped to directly shine indoors by using a continuously curved and concaved curtain piece or to shine indoors through plural bores to obtain to obtain heatproof, anti-sun but bright effect.

2. Description of the Prior Art

A conventional curtain structure is used to shield sunshine and insolate heat, but an indoor space will become dim after sunshine is shielded by the curtain. Therefore, the conventional curtain structure is additionally provided with an adjusting structure to adjust an angle of a curtain piece so as to obtain a heatproof and bright purpose.

Nevertheless, such a conventional curtain structure is produced at a high cost and has to be installed to a desired position by a professional worker without being removed easily, thus limiting installing place. Besides, it is not portable easily.

A conventional curtain structure is only used to shield sunshine by using its manufacture material instead of its designed structure, therefore after the sunshine is shielded by the curtain structure, the indoor space become dim.

The present invention has arisen to mitigate and/or obviate the afore-described disadvantages.

### SUMMARY OF THE INVENTION

The primary object of the present invention is to provide an easy curtain structure that is capable of stopping the sunshine to directly shine indoors by using a continuously curved and concaved curtain piece or to shine indoors through plural bores to obtain heatproof, anti-sun but bright effect.

To obtain the above objectives, an easy curtain structure contains:

a curtain piece formed in a continuous curve and concave shape, allowing to be folded, including a plurality of bores disposed on a number of raised folding ribs thereof respectively in a cross arrangement, and including at least one positioning structure mounted on a top and a bottom ends thereof respectively so as to be expended and to be fixed by using the positioning structure, wherein the positioning structure includes at lease one sucker fixed on the top and the bottom ends of the curtain piece.

### BRIEF DESCRIPTION OF THE DRAWINGS

FIG. 1 is a perspective view showing the assembly of an easy curtain structure according to a preferred embodiment of the present invention;

FIG. 2 is a plan view showing a plurality of bores disposed on a number of raised folding ribs of a curtain piece in a cross arrangement;

FIG. 3 is a plan view showing the operation of the easy curtain structure according to the preferred embodiment of the present invention;

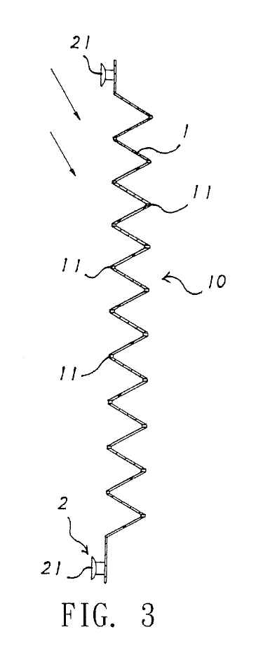

FIG. 4 is another perspective view showing the assembly of the easy curtain structure according to the preferred embodiment of the present invention;

FIG. 5 is another perspective view showing the assembly of the easy curtain structure according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

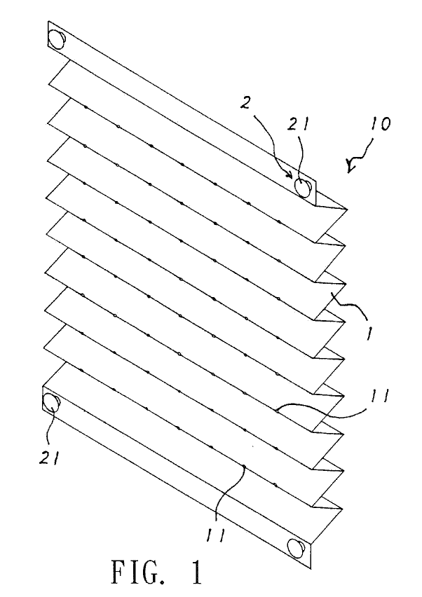

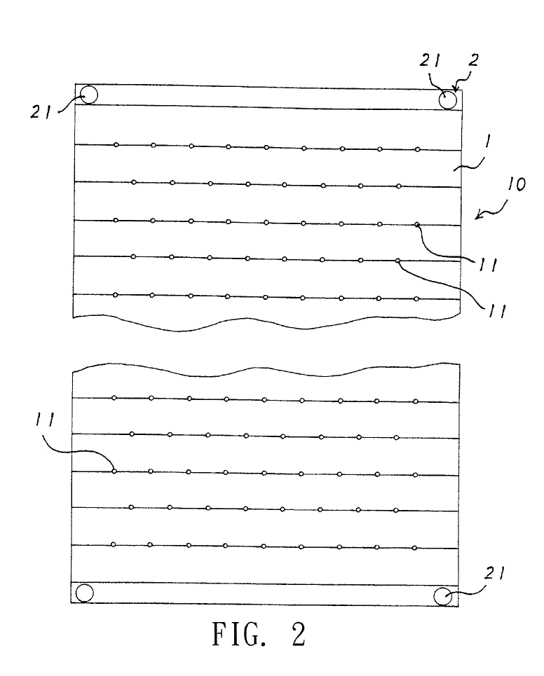

An easy curtain structure 10 according to a preferred embodiment of the present invention comprises a curtain piece 1 formed in a continuous curve and concave shape, allowing to be folded (as shown in FIG. 1), including a plurality of bores 11 disposed on a number of raised folding ribs thereof respectively in a cross arrangement (as illustrated in FIG. 2), and including at least one positioning structure 2 mounted on a top and a bottom ends thereof respectively so as to be expended and to be fixed by using the positioning structure 2.

Because the curtain structure 10 includes the curtain piece 1 formed in the continuous curve and concave shape and allowing to be folded, its production cost is lowered greatly (due to the curtain piece 1 is capable of being integrally formed), and the curtain piece 1 is folded and expanded easily and quickly. Moreover, the bores 11 are disposed on curtain piece 1 in the cross arrangement, therefore sunshine is not aligned with the bores 11 to directly shine indoors, e.g., the sunshine is stopped to directly shine indoors by the continuously curved and concaved curtain piece 1 or through the bores 11 to obtain heatproof, anti-sun but bright effect.

The positioning structure 2 includes at lease one sucker 21 fixed on the top and the bottom ends of the curtain piece 1 to attach the curtain structure 10 on a window or a wall securely so as to shield sunshine, and the curtain piece 1 is removed easily from the window or the wall to store the curtain structure 10.

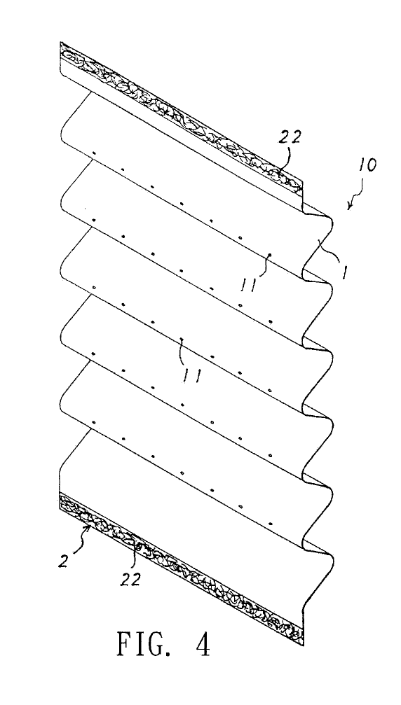

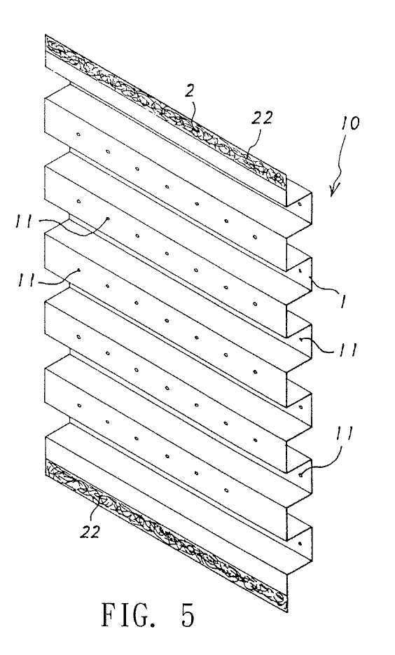

The positioning structure 2 also includes al least one adhesive tape 22 secured on the top and the bottom ends of the curtain piece 1 (as shown in FIGS. 4 and 5, the curtain piece 1 is formed in different continuous curve and concave shapes individually), hence the curtain structure 10 allows to be attached to and removed from any positions randomly.

While we have shown and described various embodiments in accordance with the present invention, it is clear to those skilled in the art that further embodiments may be made without departing from the scope of the present invention.

What is claimed is:

1. An easy curtain structure comprising a curtain piece formed in a continuous curve and concave shape, allowing to be folded, including a plurality of bores disposed on a number of raised folding ribs thereof respectively in a cross arrangement, and including at least one positioning structure mounted on a top and a bottom ends thereof respectively so as to be expended and to be fixed by using the positioning structure.

2. The easy curtain structure as claimed in claim 1, wherein the positioning structure includes at lease one sucker fixed on the top and the bottom ends of the curtain piece.

3. The easy curtain structure as claimed in claim 1, wherein the positioning structure includes al least one adhesive tape secured on the top and the bottom ends of the curtain piece.
